(19) United States
(12) Patent Application Publication
(10) Pub. No.: US 2002/0085033 A1
(43) Pub. Date: Jul. 4, 2002

(54) Process for generating a user interface in a data processing system

(75) Inventors: Patricia A. Robinson, Novi, MI (US); Prakash Reddy, Rochester Hills, MI (US); Matthew Coen, Livonia, MI (US)

Correspondence Address: William T. Ellis, Foley & Lardner, Washington Harbour, 3000 K Street, N.W., Suite 500, Washington, DC, 20007-5143, US

(73) Assignee: G.E. INFORMATION SERVICES, INC.

(21) Appl. No.: 10/026,676

(22) Filed: Dec. 27, 2001

Related U.S. Application Data
(60) Provisional application No. 60/258,288, filed on Dec. 27, 2000.

(51) Int. Cl. G09G 5/00

(52) U.S. Cl. 345/762

(57) ABSTRACT

A system and method for dynamically developing a user interface in an existing software application includes invoking a user interface developer component during the execution of the software application, identifying one or more fields to include in the user interface, and associating a field type for each of the identified one or more fields. The identified one or more fields and associated field types are saved in a user interface definition file. The user interface is generated based on the user interface definition file during the execution of the software application.

### RELATED APPLICATIONS

This application claims priority to Provisional Application Serial No. 60/258,288 filed on Dec. 27, 2000 under 35 U.S.C. §119(e).

### FIELD OF THE INVENTION

The present invention relates generally to interfaces in software application, and more particularly to a system and method for dynamically generating a user interface for a software application in a data processing system.

### BACKGROUND OF THE INVENTION

In conventional software applications users receive and enter information through various user interfaces. The user interfaces typically prompt the user to enter information or to select among several options or both. For example, in a word processing application a user interface for printing a document may prompt the user to indicate how many copies to print and to select which of a plurality of printers at which to print the document.

To display the user interfaces, the conventional software applications are programmed to initiate the display of a user interface in response to some action by the user. The action by the user is typically a mouse click or a keyboard input. For example, after preparing a document in a word processing application, a user may opt to save the document by clicking on a save button from a menu, which causes the word processing application to display a user interface that prompts the user to enter information used to save the document.

The user interfaces of the conventional software applications are already included in the programming of the application. As a result, the user interfaces are generally static, meaning that they cannot be changed. Some applications, however, allow the user to alter the content of the user interface. For example, an e-mail interface may be altered to include or remove an address line, such as the blind carbon copy (BCC) address line. Even with these alterations, a user is limited in their ability to design user interfaces existing in the software application and is unable to create any new user interfaces.

### SUMMARY OF THE INVENTION

Briefly, a method consistent with the present invention for dynamically developing a user interface in an existing software application includes invoking a user interface developer component during the execution of the software application, identifying one or more fields to include in the user interface, and associating a field type for each of the identified one or more fields. The identified one or more fields and associated field types are saved in a user interface definition file. The user interface is generated based on the user interface definition file during the execution of the software application.

In another aspect of the present invention, the method also includes providing one or more values for at least one of the identified one or more fields depending upon the associated field type, and saving the one or more values in the user interface definition file.

In a further aspect of the present invention, the user interface definition file is saved as an XML file.

### BRIEF DESCRIPTION OF THE DRAWINGS

FIG. 1 is a block diagram of a user interface developer consistent with the present invention.

FIG. 2 is a flow diagram of a process for developing a user interface in a software application consistent with the present invention.

FIG. 3 is a flow diagram of a process generating the user interface developed in the process of FIG. 2.

FIG. 4 shows an example of a software application with a pull down menu for invoking the UI developer.

FIG. 5 shows an example of a user interface displayed by the custom interface editor for developing a new interface.

FIG. 6 shows an example of a user interface created by the UI generator.

### DETAILED DESCRIPTION OF THE PREFERRED EMBODIMENT

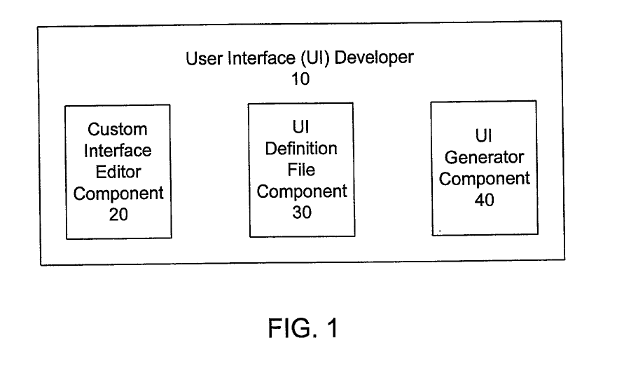

FIG. 1 is a block diagram of a user interface (UI) developer 10 consistent with the present invention. The UI developer 10 includes a custom interface editor component 20, a UI definition file component 30 and a UI generator component 40. The UI developer 10 enables a user to create new user interfaces in an existing software application. The UI developer 10 may be included in the software application, may be added as a plug-in to the existing software application, or may be a separate software application operating in conjunction with an existing software application.

The custom interface editor component 20 is an interactive editor that facilitates the creation of new user interfaces by the user. The custom interface editor component 20 may be implemented as a text or graphical interface that prompts the user to enter information for creating the user interface. The information provided by the user includes titles or labels for the interface, data entry fields, data for the fields, sources of data for the fields, labels for the fields, identification of the field type, locations of the fields, and any other relevant information that may be entered for display or to facilitate display in an interface. To facilitate the entry of the information, the custom interface editor component 20 can provide a list of options to the user, such as create new field, delete field, provide name of field, type of field, values for field or sources of values. These options may be displayed, for example, through a GUI or a pull-down menu. The user can select an option with a click of a pointing device or with a keyboard input, for example.

The UI definition file component 30 creates and stores UI definition files that are generated from the information entered by the user in the custom interface editor component 20. The structure of the UI definition file may be serialized objects or a delimited record. The UI definition file is preferably stored in a neutral format, such as XML, with a name that can be referenced by the software application. The software application for which the user interface is created references the UI definition file by its name at the appropriate time during the execution of the software application. The referencing of the file may be in response to a trigger during the execution of the software application, such as an input from the user or after the completion of some process.

The UI generator component 40 creates the user interface during the execution of the software application. In response to a trigger of the user interface, the UI generator component 40 identifies the applicable UI definition file created by the UI definition file component 30. The identified UI definition file is read by the UI generator component 40 to create a format that can be displayed. The transformation may, for example, create one or more GUI objects based on the file, such as Java GUI objects or other types of object oriented objects. The UI generator component then generates the user interface based on the GUI objects.

The UI developer 10 may be implemented in software, in hardware or in some combination thereof. In a software implementation, the UI developer 10 may be implemented as an independent software application that works in conjunction with a different software applications to create and generate user interfaces for the different software applications. Alternatively, the UI developer 10 can be programmed and integrated into a software application, such as a business-to-business or electronic data interchange (EDI) application. The UI developer 10 can also be implemented as a plug-in application that is added to an existing software application.

The UI developer 10 may be implemented on a workstation or server having a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the workstation or server provides a two-way data communication coupling via a network link to a network. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network. The network may be implemented, for example, as a LAN or as a public network, such as the Internet.

If the network is implemented as the Internet, the workstation or server can transmit a requested code for an application program through the Internet, an ISP, the local network and the communication interface. The received code can be executed by the CPU in the workstation or server as it is received, stored in the storage device, or stored in some other non-volatile storage for later execution. In this manner, a user at the workstation or server may obtain application code in the form of a carrier wave.

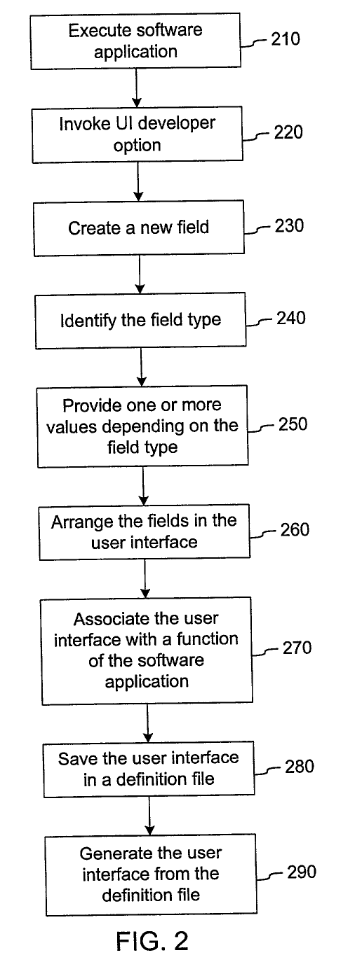

FIG. 2 is a flow diagram of a process for developing a user interface in a software application consistent with the present invention. As shown in FIG. 2, a user executes a software application (step 210). The software application may be any type of application, such as a business-to-business or EDI application like “Application Integrator™” supplied by GE Global Exchange Services, that uses interfaces to display information to the user and receives information from the user. The software application may be initiated by a click of a pointing device or with a keyboard input.

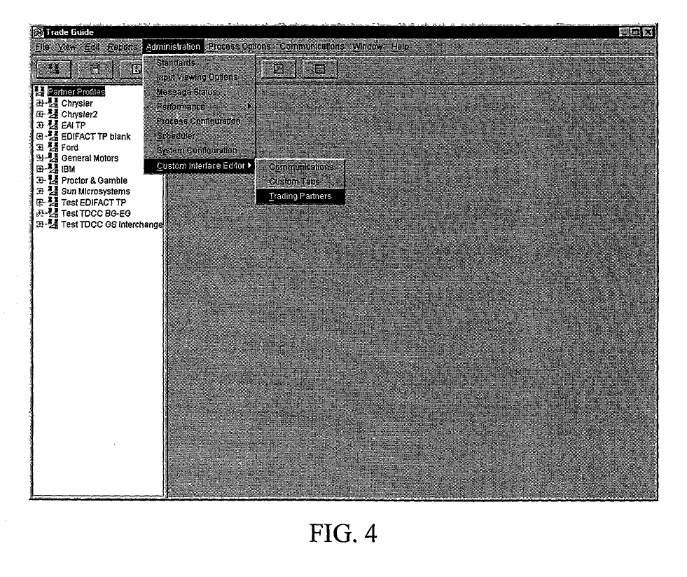

With the software application executing, the user invokes the UI developer 10 (step 220). As described above, the UI developer 10 may be integrated with the software application, be added as a plug-in to the software application, or may be an application executed independently of the software application. As an independent application, it is possible for the UI developer 10 to be invoked and executed without the software application executing. When integrated with the software application or added as a plug-in, the UI developer 10 can be invoked, for example, from a pull-down menu in the software application or by means of an icon, or some other convenient method. FIG. 4 shows an example of a software application with a pull down menu for invoking the UI developer 10. The invocation of the UI developer 10 causes the custom interface editor component 20 to be called.

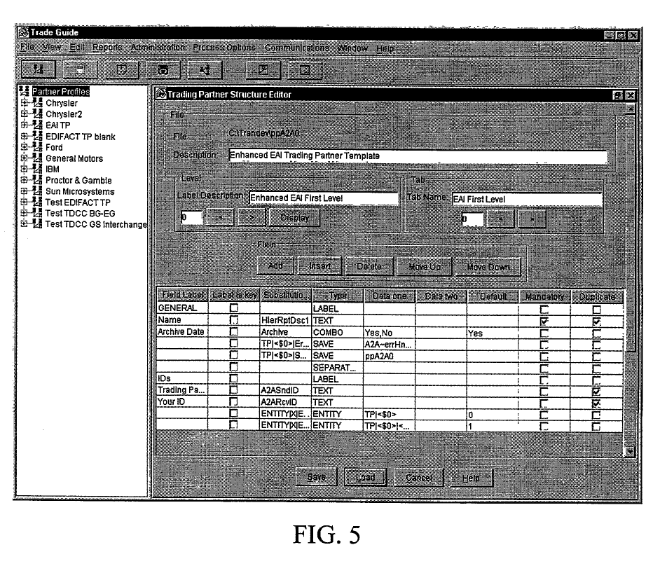

To create a new interface, the user is prompted to create a new field by the customer interface editor component 20 (step 230). FIG. 5 shows an example of an interface displayed by the custom interface editor 20 to help the user develop or edit the new interface. Each new interface can have one or more fields. For each field, the user can set forth a label that describes the type of information in the field or to be entered in the field. Typical field labels include, for example, name, address, telephone number, cost, etc.

In addition to labeling the field, the user identifies the field type (step 240). There are several different field types including, for example, a text field, a combo field, a numeric field, a date field, a time field and a fixed field, as well as any other type of field that may be included in an interface. With respect to FIG. 5, the field type is designated, for example, as ‘TEXT’ for text fields and ‘COMBO’ for a combo field. The text field is used in the interface to prompt a user to enter alphanumeric data, such as an address. The custom interface editor component 20 includes a check box to identify the text field as being mandatory or optional.

The combo field includes values that can be displayed in a drop down list displayed in the interface to the user. The combo field can be a static field or a modifiable field. As a static field, the combo field includes a list of one or more values from which a user selects. Since the user must select one of the listed values, the static combo field is always mandatory. The modifiable combo field allows the user to enter something other than the values listed in the list. The modifiable combo field may be mandatory or optional.

The numeric field is similar to the text field, except the values entered in the field are limited to numeric characters. After entering a value, the numeric field validates that the value is solely numeric characters. The date and time fields are for entry of dates and times, respectively. The date and time fields can be set to receive the dates and times in a specific format. For example, the date field may be in the format MM/DD/YYYY, and the time field may be in the format of HH:MM. The fixed field creates a text box that always displays the same data, which cannot be edited.

In addition to identifying the field type, the user can provide one or more values depending upon the field type (step 250). For example, the user can provide values for any of the combo fields. To enter the values, the custom interface editor 20 may provide a box in which to enter the values. To separate the values, the user can use commas or semicolons between each value. The values are preferably entered in the order in which they are to be displayed. The values displayed in the user interface may be different from the values entered by the user. For example, if the values entered are the states of the United States, the user may enter the two letter abbreviation, but the full name of each state would be displayed in the user interface.

After creating each of the fields to appear in the interface, the user arranges the fields (step 260). The custom interface editor 20 preferably includes a graphical user interface that helps the user to arrange the design of the fields in the interface, via dragging or some other convenient method. Alternatively, the custom interface editor 20 may provide a selection of templates from which the user selects the style and structure of the interface. In addition, the custom interface editor 20 may be configured to automatically arrange or structure the fields without user input.

Having created and arranged the structure of the user interface, the user associates the interface with a function of the software application (step 270). The custom interface editor 20 may provide a list of functions to which to associate the interface. Alternatively, the user may enter a function designation. The association of the interface with a particular function provides a mechanism for the software application to invoke the generation of the interface in response to a trigger.

All of the information associated with the user interface is saved in a definition file (step 280). As described above, the structure of the UI definition file may be as serialized objects or a delimited record. The UI definition file is preferably stored in a neutral format, such as XML, with a name that can be referenced by the software application. During the execution of the software application, the user interface is generated from the UI definition file (step 290).

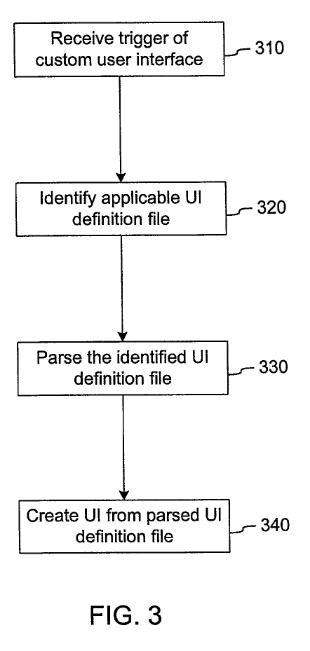

FIG. 3 is a flow diagram of a process generating the user interface developed in the process of FIG. 2. As shown in FIG. 3, during the execution of the software application, a trigger is received to generate the custom user interface (step 310). The trigger may be in response to an input received from the user by the software application, such as a click of a pointing device or a keyboard input. The input received from the user may be the selection of the function associated with the user interface from a drop-down menu. Alternatively, the trigger to generate the customer user interface may occur automatically during the execution of the software application. For example, if the software application is for the generation of request for purchases (RFPs), the custom user interface may be automatically triggered during the process for generating the RFP. The custom user interface in such a process may be the selection of vendors from a particular list.

In response to the trigger, the applicable UI definition file is identified (step 320). The trigger provides an indication as to which UI definition file should be referenced. For example, when the function associated with the custom interface is selected from a drop-down menu, the selection of the function provides the indication of the applicable UI definition file. The indication may be, for example, the saved name of the UI definition file.

The identified UI definition file is then parsed (step 330). The parsing of the UI definition file is effected by the UI generator component 40. As described above, the structure of the UI definition file may be in the form of serialized objects or a delimited record, such as an XML file, with a name that can be referenced by the software application. Based on the structure of the UI definition file, the UI generator component 40 can parse the data in the file and determine how to generate the user interface. For example, if the UI definition file is an XML file, the UI generator component 40 may refer to the DTD or XSD of the XML file to understand the structure of the UI definition file and parse it. The parsed UI definition file can be transformed into one or more GUI objects. The GUI objects may be, for example, Java objects or other type of object oriented programming language.

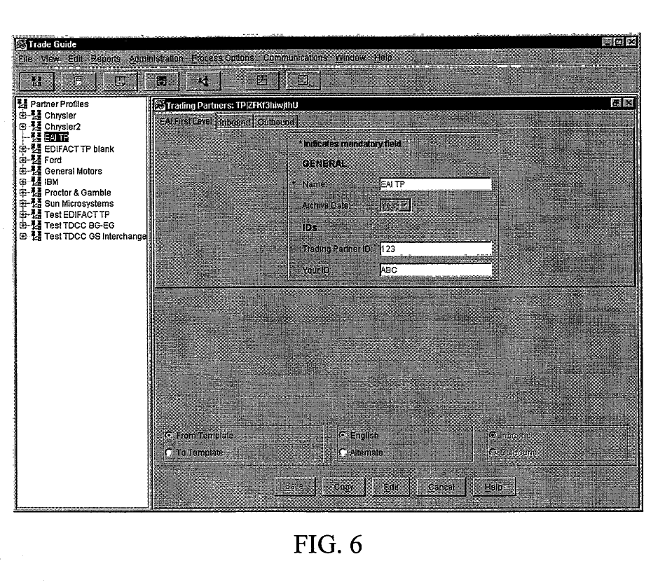

With the GUI objects transformed from the parsed UI definition file, the UI generator component 40 creates the user interface (step 340). The created user interface is displayed in the appropriate location of the executing software application. FIG. 6 shows an example of a user interface created by the UI generator component 40. As shown in FIG. 6, the user interface includes a ‘GENERAL’ section and an ‘IDs’ section. The General section includes a ‘Name’ text field and an ‘Archive Data’ combo field. The IDs section includes a ‘Trading Partner ID’ text field and a ‘Your ID’ text field. In addition, the Name text field in the General section is a mandatory field. Making this field mandatory is done by checking the box corresponding to that field in the interface shown in FIG. 5. These sections and fields are generated from the information entered by the user as shown in FIG. 5, which is the interface displayed by the custom interface editor 20 to help the user develop the new interface shown in FIG. 6.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and as a practical application to enable one skilled in the art to utilize the invention in various embodiments and with various modifications that are suited to the particular use contemplated. It is intended that the scope of the invention be defined by the claims appended hereto and their equivalents.

What is claimed is:

1. A method for dynamically developing a user interface in an existing software application, comprising:
invoking a user interface developer component during the execution of the software application;
identifying one or more fields to include in the user interface;
associating a field type for each of the identified one or more fields;
saving the identified one or more fields and associated field types in a user interface definition file; and
generating the user interface based on the user interface definition file during the execution of the software application.

2. A method according to claim 1, further comprising:
providing one or more values for at least one of the identified one or more fields depending upon the associated field type; and
saving the one or more values in the user interface definition file.

3. A method according to claim 1, wherein the user interface definition file is saved as an XML file.

4. A method according to claim 1, wherein the generating includes parsing the user interface definition file to generate the user interface.

5. A method according to claim 4, wherein the generating further includes transforming the parsed user interface definition file into one or more objects.

6. A method according to claim 5, wherein the one or more objects are Java objects.

7. A method according to claim 5, wherein the generating further includes displaying the user interface based on the one or more objects.

8. A method according to claim 1, wherein the user interface developer component is implemented as a plug-in for the software application.

9. A software application operable on a computer system having a user interface developer component for dynamically developing a user interface for the software application, the software application configured to:
invoke the user interface developer component during the execution of the software application;
identify one or more fields to include in the user interface;
associate a field type for each of the identified one or more fields;
save the identified one or more fields and associated field types in a user interface definition file; and
generate the user interface based on the user interface definition file during the execution of the software application.

10. A software application according to claim 9, further configured to:
provide one or more values for at least one of the identified one or more fields depending upon the associated field type; and
save the one or more values in the user interface definition file.

11. A software application according to claim 9, wherein the user interface definition file is saved as an XML file.

12. A software application according to claim 9, further configured to parse the user interface definition file to generate the user interface.

13. A software application according to claim 12, further configured to transform the parsed user interface definition file into one or more objects.

14. A software application according to claim 13, wherein the one or more objects are Java objects.

15. A software application according to claim 13, further configured to display the user interface based on the one or more objects.

16. A software application according to claim 9, wherein the user interface developer component is implemented as a plug-in for the software application.

17. A computer system for dynamically developing a user interface for a software application, comprising:
a processor; and
a memory, coupled to the processor, comprising a plurality of instructions executed by the processor, the plurality of instructions configured to:
invoke a user interface developer component during the execution of the software application;
identify one or more fields to include in the user interface;
associate a field type for each of the identified one or more fields;
save the identified one or more fields and associated field types in a user interface definition file; and
generate the user interface based on the user interface definition file during the execution of the software application.

18. A computer system according to claim 17, the memory further comprising instructions configured to:
provide one or more values for at least one of the identified one or more fields depending upon the associated field type; and
save the one or more values in the user interface definition file.

19. A computer system according to claim 17, wherein the user interface definition file is saved as an XML file.

20. A computer system according to claim 17, the memory further comprising an instruction configured to parse the user interface definition file to generate the user interface.

21. A computer system according to claim 20, the memory further comprising an instruction configured to transform the parsed user interface definition file into one or more objects.

22. A computer system according to claim 21, wherein the one or more objects are Java objects.

23. A computer system according to claim 21, the memory further comprising an instruction configured to display the user interface based on the one or more objects.

24. A computer system according to claim 17, wherein the user interface developer component is implemented as a plug-in for the software application.

25. A computer readable medium on a computer system having a user interface developer component for dynamically developing a user interface in a software application, the computer readable medium configured to:
invoke the user interface developer component during the execution of the software application;
identify one or more fields to include in the user interface;
associate a field type for each of the identified one or more fields;
save the identified one or more fields and associated field types in a user interface definition file; and
generate the user interface based on the user interface definition file during the execution of the software application.

26. A computer readable medium according to claim 25, further configured to:
provide one or more values for at least one of the identified one or more fields depending upon the associated field type; and
save the one or more values in the user interface definition file.

27. A computer readable medium according to claim 25, wherein the user interface definition file is saved as an XML file.

28. A computer readable medium according to claim 25, further configured to parse the user interface definition file to generate the user interface.

29. A computer readable medium according to claim 28, further configured to transform the parsed user interface definition file into one or more objects.

30. A computer readable medium according to claim 29, wherein the one or more objects are Java objects.

31. A computer readable medium according to claim 29, further configured to display the user interface based on the one or more objects.

32. A computer readable medium according to claim 25, wherein the user interface developer component is implemented as a plug-in for the software application.

33. A system for dynamically developing a user interface in an existing software application, comprising:
means for invoking a user interface developer component during the execution of the software application;
means for identifying one or more fields to include in the user interface;
means for associating a field type for each of the identified one or more fields;
means for saving the identified one or more fields and associated field types in a user interface definition file; and
means for generating the user interface based on the user interface definition file during the execution of the software application.

34. A system according to claim 33, further comprising:
means for providing one or more values for at least one of the identified one or more fields depending upon the associated field type; and
means for saving the one or more values in the user interface definition file.

35. A system according to claim 33, wherein the user interface definition file is saved as an XML file.

36. A system according to claim 33, wherein the means for generating includes means for parsing the user interface definition file to generate the user interface.

37. A system according to claim 36, wherein the means for generating further includes means for transforming the parsed user interface definition file into one or more objects.

38. A system according to claim 37, wherein the one or more objects are Java objects.

39. A system according to claim 37, wherein the means for generating further includes means for displaying the user interface based on the one or more objects.

40. A system according to claim 33, wherein the user interface developer component is implemented as a plug-in for the software application.
